(19) United States
(12) Patent Application Publication
(10) Pub. No.: US 2008/0061236 A1
(43) Pub. Date: Mar. 13, 2008

(54) Device For Assisting In Finding An Article

(76) Inventors: Paul Meredith, Pullenvale (AU); Andred Zvyagin, Riverhills (AU); Devlin Wollstein, Kangaroo Point (AU)

Correspondence Address: BEYER WEAVER LLP, P.O. BOX 70250, OAKLAND, CA, 94612-0250, US

(21) Appl. No.: 11/660,726

(22) PCT Filed: Aug. 19, 2005
(86) PCT No.: PCT/AU05/01251

§ 371 Date: Sep. 21, 2007

(30) Foreign Application Priority Data
Aug. 20, 2004 (AU) 2004904736

(51) Int. Cl. G01J 5/10

(52) U.S. Cl. 250/338.1

(57) ABSTRACT

An apparatus for assisting in finding an article such as a golf ball (2) includes a housing (3) containing a laser diode (4) for radiating an excitation beam (5) in the UV or IR bands. The apparatus has a receiving lens (9) for receiving a return beam (8) sent back from the golf ball (2) by the fluorescent coating on the ball. The return beam (8) falls on a photodiode receiver (10) after passing through two filters (11, 12) which filter out incident sunlight. Processing means (15) processes the signal received by the receiver and drives an indicator (18) in the form of a beeper or flashing light which indicates that the golf ball (2) has been sensed by the apparatus.

### BACKGROUND OF THE INVENTION

1. Field of the Invention

This invention relates to a device for assisting in finding an article. The invention also extends to an apparatus comprising the device as described above in combination with a modification to the article, to enable it to be located by the device.

This invention relates particularly but not exclusively to a device for assisting and finding a partially concealed golf ball. It will therefore be convenient to hereinafter describe the invention with reference to this example application. However it is to be clearly understood that the invention is capable of broader application. In fact a characteristic of this invention is that it can be used in so many applications it would not be possible to list them in this specification

For example the invention may also be applied to applications for locating missing persons. In many aerial search and rescue operations it can be exceedingly difficult to pin point the location of the desired target. For instance in air-sea rescue operations location of missing persons is made more difficulty due to the turbulent nature of the ocean's surface. A choppy sea, further compounds location efforts as a person or persons can be camouflaged by surface waves.

Similar difficulties are experienced in attempting to locate lost snow skiers. Snow is often soft and people can easily fall and become partially or fully covered by a layer of snow, eg in a snow drift, or they may get caught in an avalanche. It is notoriously difficult to locate people in snow when this happens. Put simply the person is covered with loose snow and is not readily visible to a search and rescue party.

An important application in this invention is to assist in locating persons in these situations.

2. Discussion of the Background Art

Golf courses generally contain rough as well as manicured fairways and greens. While it is usually the object of a golf player to keep their ball on the fairway and greens this does not always occur. Sometimes the ball gets hit into the rough, particularly after a drive. The rough generally contains long grass and scrub brush of at least several inches height. In particularly harsh conditions the rough can be up to six inches long.

However the diameter of a golf ball is less than two inches or fifty millimetres and consequently when a ball lies beneath the top of the grass in the rough it can be hard to see. Thus from a distance a ball lying in the rough may not be visible to the golfer walking up the fairway from the tee.

This problem of looking for balls that have ended up in the rough has plagued golfers for generations. A lot of time and energy is wasted looking for their balls and it also slows down play. On modern golf courses the players are actively managed by a course marshal. As such they only have a limited amount of time to play each hole. Thus if they hit the ball into the rough they do not have much time to find it.

In addition when a golf player loses a golf ball they suffer an economic loss that is not insignificant. This is particularly so in the modern era of high technology golf balls. Many players, even social and club players, choose balls that they hope will give them a competitive advantage in distance or feel. However this technology comes at a significant monetary cost and it is not unusual for golfers to play with golf balls that cost ten to fifteen dollars each.

The problem of finding golf balls not only occurs when the balls are hit into long grass. Sometimes the ball becomes plugged in muddy or heavy ground and can be hard to see. This is because most of the surface of the gold ball is received in the ground and only a very small area remains exposed.

Further sometimes a ball can land in a water hazard, eg in shallow water, and can be difficult to find. Further even if the water is shallow the ball may be partially obscured by weeds and the like. It may also be partially covered by mud.

Clearly it would be advantageous if a device could be devised that would assist in finding and recovering these golf balls. It would save golfers a lot of effort. It would also save golfers a lot of money.

Further often people get lost at sea and float around in the sea being kept afloat by a life jacket while they wait to be rescued. It can be notoriously difficult to find people floating in the sea particularly in the dark and also in rough and stormy conditions. Current rescue techniques rely on a search party actually visually spotting the person in the sea with their eyes or binoculars from a helicopter or the like. The limitations of this technique have been well recognised. After the person has been spotted and their location identified they can be physically picked up by either a boat in the water or from the air.

Clearly it would be advantageous if a way could be devised of locating the person in the sea. This would make it a lot easier to rescue people and it would also speed up the rescue process.

In addition it is not unusual for people to get lost in the snow while they are skiing. Snow is often soft and people can easily get covered by the snow. They might fall and get covered by snow, eg in a snow drift, or they may get caught in an avalanche and get covered by snow. It is notoriously difficult to locate people in snow when this happens. Put simply the person is covered with loose snow and is not visible to a search and rescue party. Clearly it would be beneficial if an apparatus could be devised to assist in locating these people in the snow. It would reduce the number of people who die as a result of getting lost in the snow. It would also assist the search and rescue process and lower the considerable cost of a search and rescue process.

### SUMMARY OF THE INVENTION

### Disclosure of the Invention

Accordingly in one aspect of the present invention there is provided an apparatus for locating an article said apparatus including:

a source of electromagnetic radiation capable of illuminating the general area containing the article to be located;

an absorber associated with said article and responsive to said radiation;

an emitter associated with said article and responsive to absorption by said absorber; and

a detector capable of detecting emission by said emitter and providing an output indicating to the location of said article.

In another aspect of the present invention there is provided a method of locating an article, the method including the steps pf:

providing said article with an absorber selected to absorb incident electromagnetic radiation of a selected frequency;

providing said article with an emitter selected to emit electromagnetic radiation in response to illumination of said absorber by said incident radiation; and

detecting said emitted radiation

Preferably the method includes actively illuminating the article with a radiation source capable of illuminating the general area in which the article is expected to be found. This may be done by flooding the field of view or by scanning a narrow beam of radiation across the search area.

Thus the electromagnetic (em) radiation generated by the source is emitted in the general direction of the article to be located. Upon striking the article a portion of the incident energy of the em radiation is absorbed by the absorber. The absorbed energy then causes the emitter to spontaneously emit em radiation (return signal) of a longer wavelength to that of the incident radiation emitted by the source.

Thus the apparatus in accordance with this aspect of the invention utilises the principle that the energy of the em radiation generated by the emitter will always have a longer wave length and lower frequency to that of the em radiation transmitted by the source in order to locate the article. The difference between the wavelength of the em radiation of the source and that of the return signal from the emitter also allows the apparatus of the present invention to more accurately differentiate the return signal from background noise.

The source and the detector may be housed in a single unit such as a hand held device, the source and detector may be positioned adjacent each other within the unit. Alternatively the source and detector may be provided as separate units. Of course the absorber and the emitter are naturally separate from these components and are associated with article sought to be located, eg they may be disposed on the outer surface of the article.

The apparatus may be held by the person looking for the article to be located. They may control the transmission of the em radiation form the source in the general vicinity of the article to be located. The direction in which the apparatus is pointed indicates broadly where the article to be located is positioned. Alternatively the device may be mounted on a vehicle such as a golf buggy or motorised golf cart.

Preferably the source is capable of delivering em radiation in one of a variety of forms. For example the source may radiate a beam of visible light, UV light, IR light or radio waves. Of these IR and UV are preferred, and IR the most preferred. Where the source emits radiation in the form of radio waves, eg radio frequency oscillation waves, the radio waves are preferably within a frequency range of 500 MHz to 5 GHz. It is important to appreciate that all parts of the em spectrum are considered to be within the scope and ambit of this invention.

The source of em radiation may be operatively coupled to a signal generator, whereon activation of the device the signal generator pulse the em radiation at a predetermined frequency i.e. modulated at a certain frequency. The source may further include at least one filter and/or a mirror for screening out any background emissions.

The source may also include means for directionally focussing the generated em radiation in the general direction of the article to be located. One example of directional focussing arrangement that may be utilised in the case of UV and IR light is a collimator. Suitably the collimator is at least capable of collimating the source within about 2 mm full width half maximum beam profile.

In the case of radio waves the directional focussing arrangement may take the form of a directional antenna. It is important to focus the radio waves as they tend spread out isotopically after they are radiated and therefore they need to be focussed in the desired direction.

The apparatus may also include means for differentiating the return signal (the em radiation emitted by the emitter) from other em radiation that enters the detector. The differentiating mean may comprise filtering means for filtering out radiation other than that from the return signal. The filtering means may filter out all radiation that is not in phase with the modulated beams. The filtering means may also include a band pass interference filter and/or long wavelength pass coloured glass filter.

The filtering means may also include aperture defining means in the form of an iris aperture for limiting the field of view the detector, so as to screen out stray radiation reflected from the surface of the area being searched. The aperture defining means is directed in a general sense at the field of view of the source of em radiation. The aperture defining means thereby serves to screen out light emanating from outside the field of view defined by the aperture.

The form of the detector depends greatly upon the nature of the return signal that is radiated by the emitter associated with the article. Where the return signal emitted from the article is in the IR, UV or visible light the detector may be in the form of a photodiode. Where the return signal is in the form of radio waves, then the receiving means may be in the form of an antenna, eg a directional antenna.

The absorber and emitter may be in the form of a fluorescent material that is applied to the surface of the article such as a fluorescent or luminescent dye. For example the golf ball, life vest etc may have its outer surface coated with a thin film of such a dye.

As briefly discussed above em radiation from the source is directed toward the article and is absorbed by the fluorescent material. The absorbed energy is sufficient to induce spontaneous emission from the material (i.e. the absorbed energy causes the dye to fluoresce). The radiation emitted by the fluorescent material having a lower frequency than that of the source. The frequency shift between the source and the emission frequency is known as the Stokes Shift and is characteristic of particular fluorescent material. Thus in this embodiment the fluorescent coating is used as both the absorber and emitter. An advantage of this embodiment is that it is a relatively easy matter to coat an article with such a material e.g. the fluorescent dye is simply paint, smeared or otherwise adhered to the outer surface of the article.

The source may be any suitable em source such as a laser, laser diode or high power LED which is operatively coupled to a suitable driver circuit and a signal generator enabling the apparatus to deliver a series of em pulses. Providing a pulsed source of em radiation has a number of distinct advantages, namely the use of pulse modulation enables the return signals to be more readily distinguished simply by providing appropriate filtering mechanisms.

The source may further include a filter and/or a hot mirror mounted at an angle to the direction of the beam, e.g. 45 degrees to the direction of the beam, to suppress any spontaneous background emission. The filter and/or hot mirror may be located forward of the laser diode.

The source may also include a beam expander such as a telescopic barrel assembly for expanding the collimated beam to a desired diameter e.g. between 15 mm to 25 mm. The beam is expanded so as to produce a suitably sized field of view relative to the size of the article to be located.

Thus the generating means can be assembled from a number of components, each of which is readily available off the shelf. In particular the diode lasers are widely available due to their applications in such devices as CD and DVD players and the like.

The detector may include a receiving lens having a focal length in the range of 50 mm to 150 mm, and preferably about 100 mm focal length. With the lens being position so as to focus an image of the return signal on to the detector.

The receiving lens may be sized and shaped so as to form a real image of the article on to the detector of 0.5 mm to 15 mm, in the case of a standard golf ball (45 mm) that is 5 meters away. Preferably the size of the image is between 0.5 mm to 5 mm, more preferably between 0.75 mm to 2 mm.

The aperture defining means may be a variable iris aperture that is mounted and fixed in relation to the source and is directed to focus the source within a given field of view. Preferably the field of view of the aperture corresponds substantially with the field of view of the em radiation source. Even more preferably the field of view of the aperture is restricted to the size of the article sought to be located, eg a golf ball.

The detector may be a photo-receiver. The photo receiver may comprise one or more photo diodes, e.g. PIN photo diodes, arranged on the surface of the receiver for responding to light striking the diode and also an amplifier, eg a trans-impedance amplifier operatively coupled to said photodiodes. The photo receiver converts light striking the receiver, and more particularly the photo diodes thereof, into an electrical signal. Preferably the amplifier may increase the voltage of the electrical signal from the photo-receiver to 0.5 volts to 10 volts.

The filtering means may comprise a band-pass interference filter which permits only electromagnetic radiation within a certain wavelength range to pass therethrough. That is light with the wavelength of the return signal emitted by the fluorescent material disposed on the article. The filtering means may further include a long wavelength pass coloured glass filter which permits only a predetermined wavelength of light to pass therethrough, e.g. the wavelength corresponding to the central frequency of the return signal.

Thus the band-pass and wavelength pass filters selectively admit only a narrow band of em radiation and block em radiation is outside the wavelength of the return signal. For example if the source emits infra-red radiation at a wavelength of 635 nm, and the fluorescent material emits a return signal at 690 nm, the filters will filter out reflected light from the excitation beam at wave length of 635 nm, then the bandpass and wavelength pass filter are selected so as to admit light in the 690 nm range.

Thus the band-pass and wavelength pass filters are selected with a passband that admits only the energy band of the return signal radiated from the article, while blocking out background noise such as ambient solar radiation and radiation from the source which has been reflected from non-fluorescent objects in the field of view e.g. glass bottle, metal cans and the like.

The detector may comprise means for demodulating and converting the received return signal to a DC signal capable of activating an indicator. In particular the detector means may comprise a phase sensitive amplifier or lock-in amplifier.

The phase sensitive amplifier processes the pulsed return signal by multiplying the signal from the photo receiver by a balanced bipolar square-wave reference, and then averaging this out over a predetermined time interval, eg 1 or more seconds, preferably 1 second. Thus the phase sensitive amplifier produces an averaged DC signal from the detected pulsed of the return signal. The reference for the phase sensitive amplifier is supplied by the signal generator that is coupled to the source as discussed above.

Thus the phase sensitive amplifier operates as an extremely narrow band filter that eliminates substantially all noise and spectral components other than those components that are in phase with the modulation frequency of the signal generator. Accordingly it gives a very high signal to noise ratio which enhances the reliability of the device in not giving false indicators of the location of the article.

Another benefit of pulse modulating of the source and subsequently the return beam is that it shifts the signal bandwidth above the 1/f noise spectrum of the trans-impedance amplifier electronics.

The detector may further include means for amplifying the DC signal outputted from the phase sensitive amplifier. With the configuration described above an adequate detection threshold can be set well above the noise level of the system so that the potential for false activation of the indicator is low.

The apparatus may also include an indicator for indicating to the user when the return signal emitted by the fluorescent coating has detected thereby indicating the general position of the article. The indicator may be energised to activate or trigger when the signal from the phase sensitive amplifier exceeds a certain level.

The indicating means may be a visual and/or audio indicator. Preferably visual indicator is a steady light or a flashing light. In a most preferred form the indicating means provides a visual indicator the form of a flashing light and audio indictor in the form of a beeper. The visual indicator may be an LED, eg a red or green LED.

In light of the above it will be appreciated that the design specifications of filters for the apparatus depend on the characteristics of the chosen em radiation source and on the selected absorber and emitter materials. The filters associated with the source are chosen so as to let the em radiation of the source through eg the wavelength of light generated by the laser diode the through but block background emissions. While the filters associated with the detector are chosen to admit em radiation emitted from the article and attenuate all energy out side the frequency of the radiation emitted by the emitter. Thus the filters of the system can only be specified once the frequency of the source and the frequency of the return signal produced by the emitter (which is an intrinsic property of the chosen emitter) are selected. Accordingly the specification of these filters will vary form sources to source and the chosen fluorescent materials used to coat the article.

The source may conveniently be chosen to have a wavelength at which the light will be highly absorbed by the fluorescent material that is chosen to coat the article. Suitably the source is chosen such that it radiates energy in the infrared or ultraviolet portion of the spectrum. Preferably the source radiates electromagnetic radiation or light in the infrared range. In some embodiments the source has a wavelength of 750 nm to 1000 nm. Conveniently one of 785 nm, 850 nm or 980 nm may be chosen.

Thus in preferred forms the source is chosen such that its frequency is outside that of the visible light range. While the fluorescent material is selected such that it absorbs energy within the spectral range of the source and is then capable of radiating out a return signal at a slightly longer wavelength than that of the source.

Where source is chosen such that it radiates energy in the IR or UV range the fluorescent material is chosen that it strongly absorbs radiation in the UV or IR bands of the electromagnetic spectrum, depending on which is chosen.

Thus an appropriate fluorescent material can be selected that exhibits strong absorption in the infrared or ultraviolet range, preferably infrared. This material then radiates a return signal that has a specific and longer wavelength that is a function of the wavelength of the source and the fluorescent material. This can provide a diagnostic tool for identifying light returned by the article in response to the excitation beam.

One example of a suitable coating material identified by the Applicant is 3-diethylthiadicarbocyanineiodide (TDCI). Another example of a suitable coating is 1,1′, 3,3′,3′-hexamethylindodicarbocyanine Iodide (HIDCI). However it needs to be understood many other florescent coating could also be used.

Both of the aforementioned dyes exhibit strong absorption in the infrared region giving them characteristic blue and blue-green colours. Further both dyes showed strong florescent emission, which is consistent with their high quantum yield. It needs to be appreciated that any fluorescent coating could be used that absorbed strongly in the range of the excitation beam and that these are only two example fluorescent coatings. Advantageously the coating is transparent when applied to a golf ball.

As previously mentioned the fluorescence detection aspect of the present invention can be applied in a number fields, such as security and in particular in the areas of identity theft and credit card fraud prevention. For example a credit card or personal identity card could be coated with a dye or a combination of dyes positioned in one or more locations on the card. The dyes could be modified with functional groups which bind the dye molecules to a polymer which will attach the material from which the card is made. The card could then be scanned with a reader comprising the selected lasers or LEDs or similar narrow frequency emitter. The combination of dyes and locations of the dyes could provide a unique combination of signal in response to the scanning device which could be used to verify the authenticity of the card.

A further example of the present inventions applicability to the area of information and data security is in the authentication of CD ROMS and DVD's. In such an application the upper surface or the presentational surface of the disc is coated could be coated with a dye or a combination of dyes in a similar manner to that of the identity or credit card discussed above. A reader positioned with in the appropriate player then scans the upper surface of the disc in order to verify whether the disk is an original or authorised copy.

Another envisaged application of the present invention is in the area search and rescue such as air sea rescue. In this application the source generates em radiation in the RF frequency bands. The source may generate pulsed radio waves of specific radio frequency. The source may include a directional antenna for directing the beam towards a target.

The article sought to be located contains a chip, eg a radio frequency identification device (RFID) which identifies that particular article. The RFID includes an active ASIC chip, including transistors, which is energised by the incident radiation transmitted by the source. The ASIC chip then processes the signal and in response thereto issues a return signal.

In one particularly preferred form the article to be located is a jacket, eg a heavy winter jacket, or a life jacket worn by some one being rescued in a sea rescue.

The excitation beam generating means comprises means for generating a pulsed modulated excitation signal of radio waves. The radio waves may have a frequency from 500 MHz to 5 GHz. The excitation beam generating means may include a directional antenna for directing the excitation beam in a certain direction.

Thus the RFID absorbs some of the radiation transmitted by the source. Thereafter the device processes the absorbed energy and radiates out a return beam of lower energy than the excitation beam which can be received by the receiver indicating that the article sought to be located has in fact been located.

The RFID device may be contained within a sealed capsule mounted on the outer surface of the jacket. The RFID device may further include a directional antenna for directing the return signal in the appropriate direction. This may increase the effective range of the return signal.

The RFID device may include a unique identification number assigned to a specific article which is transmitted along with the return signal so as to provide the user with an indication as to exactly which article has illuminated by the source.

The RFID device may include a battery for boosting the energy in the return signal, eg located in proximity to the chip. This may also increase the effective range of the return signal.

Applicant believes that it would be technically feasible to use the apparatus on all life jackets that are used in boats and on aircraft. This would make it easier to locate the person wearing the jacket during a rescue. The search party whether they were in a boat or an aircraft would move the device back and forth across a search field and wait to get a signal indicating that a return beam had been received.

According to another aspect of this invention there is provided an apparatus for assisting in locating an article, the apparatus comprising;
means for generating an excitation beam that is radiated in the general direction of the article to be located;
said article having a fluorescent material on its surface for receiving the excitation beam and absorbing at least some of the energy of the excitation beam and then radiating out a return beam of differing frequency to the excitation beam;
means for receiving a return beam generated by the fluorescent material including a receiver;
means for filtering out light other than that specifically forming part of the return beam emitted by the fluorescent coating on the article before it impinges on the receiver; and
a detector for processing a return signal and indicating to an operator when a said article has been detected.

The apparatus may include any one or more of the optional features of the apparatus described above according to the first aspect of the invention. For example the beam generating means may comprise a laser diode operatively coupled to a signal generator and having a filter associated therewith.

Further the detector means may comprise a receiving lens and a receiver in the form of a photo receiver for receiving and sensing the light from the return beam and an amplifier for amplifying the signal from the photo receiver.

The filtering means may comprise a band pass interference filter and also a specific wavelength pass coloured glass filter for blocking out reflected light from the excitation beam.

Further the detector may include a lock-in amplifier for demodulating the receiver signal from the return beam and converting it to a DC signal which is then amplified and used to activate an LED and/or beeper to indicate the presence of the article being looked for.

Alternatively the article may be an outdoor snow sports jacket of the type worn during skiing activities

Applicant believes that it will be feasible to use the apparatus on a large percentage of the snow jackets worn by skiers and the like because about 70% of these jackets are rented by skiers. This provides a means for directing use of this by these people.

According to yet another aspect of this invention there is provided a method of locating an article using the apparatus described above, comprising:
providing the article/s to be located with a means for receiving an excitation beam of em radiation and absorbing this radiation and then radiating out a return beam of lower energy than the excitation beam;
providing a device including an excitation beam generating means, a return beam receiving means and a filtering means and processing means;
training the device in the general direction of the article;
moving the device around until the device indicates that it has received a return beam from the fluorescent coating; and
noting the general position at which the device was pointed when the indicator activated and walking towards it to locate the article.

The method may include keeping the device trained on the position of the article to enable the user to hone in on the article, eg causing repeated indicating, eg flashing and beeping of the device.

The method may be used to locate a golf ball in the rough or camouflaged by leaves or plugged in mud.

The method may be used to locate a person in the sea who needs to be rescued. The method may also be used to locate a person covered in snow who needs to be rescued.

In this application the method may include moving the device back and forth in disciplined passes or sweeps to systematically cover a search area. It may also include using a plurality of said devices together in a systematic and disciplined manner.

### BRIEF DETAILS OF THE DRAWINGS

A device and apparatus for assisting in finding an article in accordance with this invention may manifest itself in a variety of forms. It will be convenient to hereinafter provide a detailed description of two embodiments of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

FIG. 1 is a schematic block diagram of an apparatus for finding an article such as a golf ball showing the different components of the apparatus;

FIG. 2 is a schematic illustration of the apparatus of FIG. 1 in use for locating a partially concealed golf ball;

FIG. 3 is a graph of the absorption spectra for two example golf ball coatings;

FIG. 4 is a graph of the fluorescence spectra of the two example golf ball coatings of FIG. 3;

FIG. 5 shows side by side the absorption and emission spectra of one example fluorescent coating namely HIDC and

FIG. 6 shows side by side the absorption and emission spectra of another example fluorescent coating namely TDCI

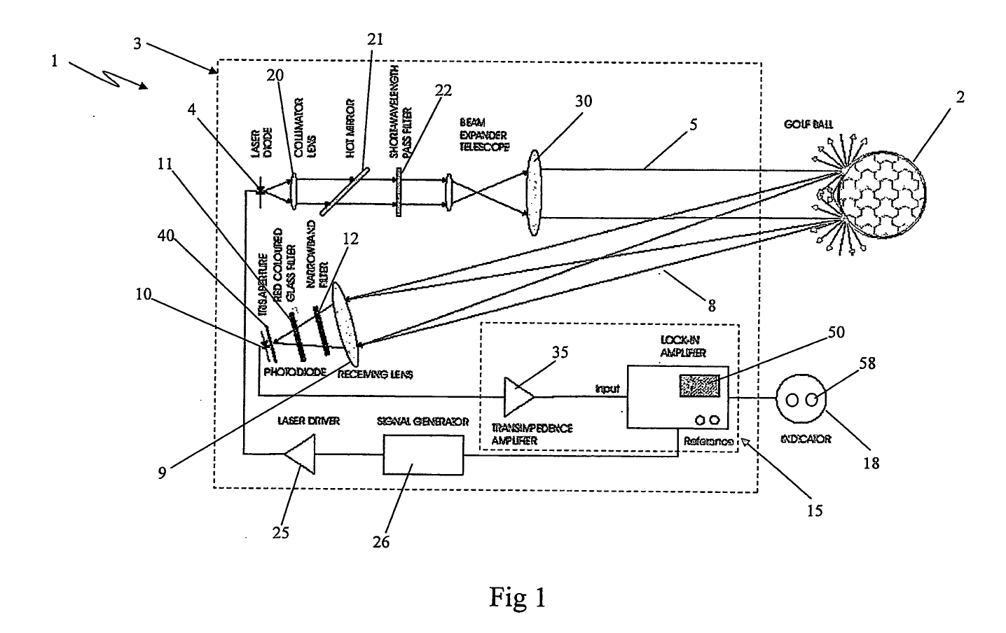

### DESCRIPTION OF EMBODIMENTS OF THE INVENTION

Apparatus for Locating a Golf Ball

An apparatus for helping to find a gold ball comprises a hand held device 1 and a golf ball 2 which is coated with a fluorescent coating.

When an excitation beam from the device strikes the coating, energy is absorbed and then retransmitted at a lower frequency and longer wave length as a return beam which can then be detected by the device.

The applicant has built a prototype of the invention in the laboratory and this prototype is described below. This prototype has been used to demonstrate the efficacy of the invention. However it is to be recognised that the final product that is produced to locate golf balls may have components in it that are not the same and have different specifications to those described below.

The device 1 comprises broadly a housing 3 containing means for radiating an excitation beam 5 including a laser diode 4. It also has means for receiving a return beam 8 in the form of a receiving lens 9 sent back from the golf ball 2 by a fluorescent coating on the ball 2 and a receiver which is a receiver 10. The device 1 also includes return beam filtering means in the form of two filters 11, 12 for filtering out incident sunlight from the return beam 8. The device also includes processing means 15 for processing the signal that passes through the filters 11, 12 and finally also indicating means 18 in the form of a beeper and a flashing light for indicating that the golf ball 2 has been sensed by the device 1. By virtue of the direction in which the device 1 is pointed at the time that it beeps the golfer is given an indication of where the ball 2 is located.

The means for radiating the excitation beam may include a collimator 20 for collimating the beam radiated from the laser diode 4 to give a beam with a certain beam width profile.

The radiating means may also include a hot mirror 21 mounted at an angle to the direction of the beam, eg 450, and a pass filter 22 to suppress any spontaneous background emission at longer wave lengths. This is important because this spontaneous radiation cannot be distinguished from the golf ball signal by the receiver 10.

In the illustrated device the collimator 20 is a THORLABS aspheric lens C11O having a focal length of 6.24 mm and giving a beam with a 2 mm full width half max beam profile.

The hot mirror 2 may be an Edmund optics 43.955 hot mirror and the pass filter 21 may be an Edmund optics 1650 nm short wavelength pass filter.

The laser diode 4 may be capable of radiating a nominal 10 mW of red light at a wave length of 634 nm. The radiating means may also include a laser driver 25 for generating the pulsed signal and also a signal generator 26 for modulating the pulsed signal.

In the illustrated version, the laser diode is a Hitachi HL6320G and the laser driver is a THORLAB LDC 205. The signal generator is a HP 33120A operating at 727 Hz to give close to 100% intensity modulation at a 50% duty cycle.

Finally the radiating means may also include a beam expanding telescope 30 for expanding the excitation laser beam up to about 20 mm diameter. This provides a reasonable correspondence with the 45 mm diameter of a golf ball at a distance of about 4 to 6 meters.

The receiving lens 9 may have a focal length of about 100 mm and the photo receiver 10 may be spatially positioned relative to the receiving lens 9 to receive the radiation from the return beam and convert it into an electrical signal. The photo receiver 10 comprises a plurality of silicon photo diodes that are operatively coupled to a transimpedance amplifier 35. The responsivity of the photo diode at 690 nm is about 0.4 A/W. The transimpedance gain is about 1.0×10⁶ V/a giving an overall response of 0.4 V/μW at this wavelength. The linear range of the amplifier 35 is 10 volts and thus the ambient light reaching the photo receiver must be limited to less than the saturation level of 25 microwatts.

The receiving means also includes the filters 12 for assisting in filtering out and blocking out light other than the fluorescent return beam radiated by the article. These filters 12 include a band-pass interference filter centred at 700 nm with an 80 nm pass-band. The filters also include a wavelength pass coloured glass filter for admitting the appropriate wavelength. These filters perform the important function of selectively admitting fluorescent light in the return beam to the photo receiver 10 and screening out other light. For example in bright sunshine on a golf course there will be a large amount of reflected and possibly also incident sunlight that has to be screened out. There will also be a large amount of reflected light from the excitation beam that also has to be screened out.

In summary the filters 12 are designed to permit only a narrow range of wavelengths that are outside of the visible white light region of the spectrum through to the photo receiver 10.

The receiving lens 9 forms a real diminished image of the ball 2 on the photo detector 10 of approximately 1 mm diameter for a 45 mm diameter ball at 5 metres.

The receiving means further includes a variable iris aperture 40 to further restrict and block em radiation other than that in the return beam emitted by the fluorescent coating. The variable iris aperture 40 is precisely aligned with laser field of view so as to only admit radiation issuing in a straight line from the field of view into the receiving means. Further the variable iris aperture 40 is very carefully aligned to coincide with the laser field of view and is also closed down to nearly match the size of the image golf ball so as to permit light from the field of view to enter the receiving means but to screen out all other light.

The photo receiver 10 is a commercially available general purpose photo receiver Thorlabs PDA520. The photo receiver 10 has a large area silicon photodiode and integral transimpedance amplifier.

The device 10 also includes processing means in the form of a phase-sensitive or lock-in amplifier 50 that is used to demodulate the pulsed fluorescent signal in the return beam coming from the article 3 which is a golf ball 2. In essence the return beam 8 is pulsed at the same rate as the excitation beam 5 and he reference details can be obtained from the signal generator 26 for the excitation beam 5. In brief the lock-in amplifier works by multiplying the receiver signal by a balanced by-polar square-wave reference and then averaging this out over a long time constant eg of one or a few seconds. As the receiver signal from the return beam is modulated or pulsed at the precise frequency of the reference, the multiplication gives rise to an average or DC signal called the DC output signal.

In essence the lock-in amplifier 50 operates as an extremely narrow filter that eliminates all but in-phase noise spectral components at the modulation frequency and gives a very high signal-to-noise ratio.

The DC output signal is then amplified to a level at which it is able to activate or trigger an indicating means.

The device 1 also includes an indicating means in the form of a visual and audio indicator 58. Specifically the indicator comprises LED devices that emit a flashing light when activated as well as a beeper that beeps when activated.

The output DC signal from the lock-in amplifier is amplified to a level appropriate to trigger or activate the audio and visual indicator when it receives a return beam from the fluorescent coated article. An adequate detection threshold can be set well above the noise level system so that the risk of false triggering by system noise is low.

The fluorescent coated article will now be discussed. In the example embodiment this article is a golf ball which is coated with a thin coating of the fluorescent material. As discussed above the fluorescent material is necessary to absorb energy from the excitation beam and then reradiate or emit this energy in the form of a return beam having certain specific properties that are a function of the excitation beam and the fluorescent material and that thereby enable the return beam to be identified.

Applicant has conducted experiments with two fluorescent coatings. These are TDCI and HIDCI. Applicant found that it was able to apply these dyes to the golf balls and that they were suitable for the task. However it needs to be understood that many other fluorescent coatings could also be used and these two particular compounds are just examples.

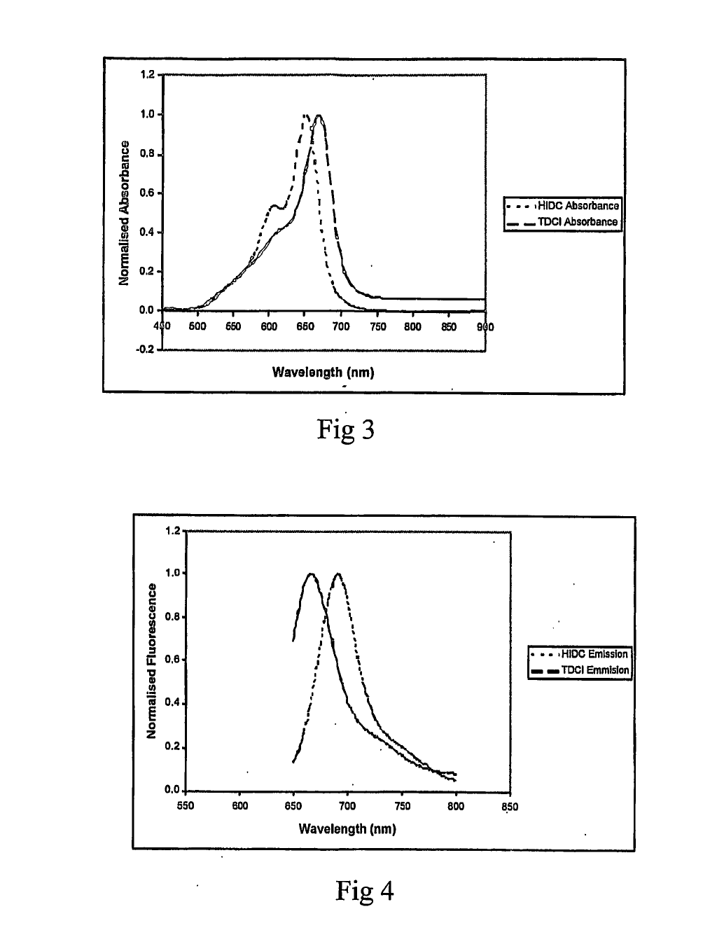

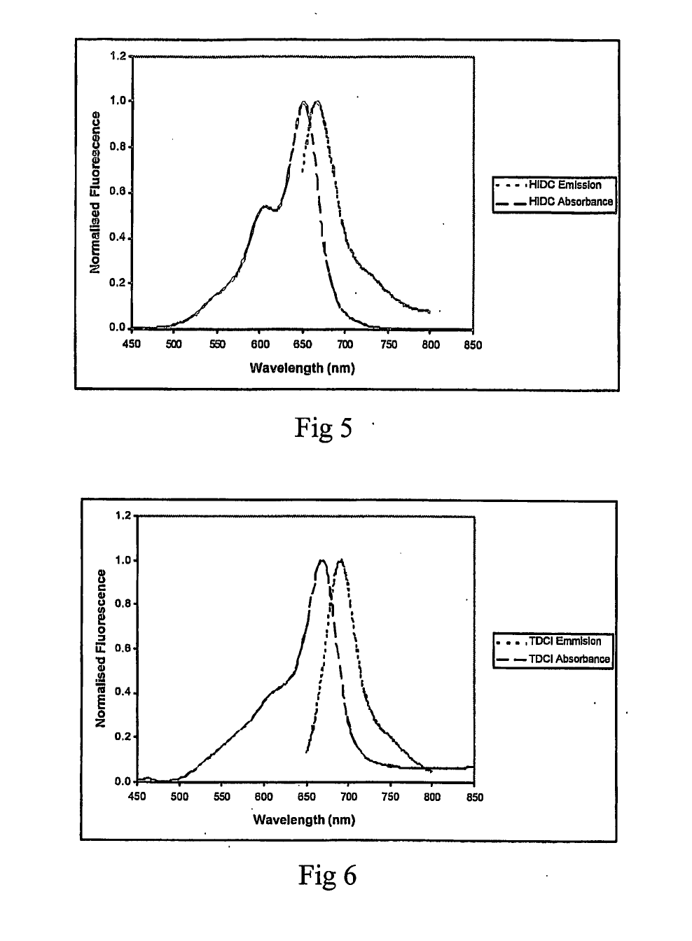

The absorption spectra of both the TDCI and HIDCI dyes is shown in FIG. 3. The dyes show strong absorption in the wavelength of red light giving them the characteristic blue and blue-green colours. Further each dye has a high molar absorption coefficient which is important because it is this absorbed energy which is then reradiated as the return beam. The emission spectrum for each dye is shown in FIG. 4. Both dyes show strong emission with high quantum yields.

A characteristic of a fluorescent material, eg a coating, is the so called Stokes shift which is a difference in energy or wavelength between the absorption and emission maxima. Thus the maxima positions are different. The maximum wavelength of the emission is greater than that of the absorption. Thus knowledge of the difference between the absorption maxima and the emission maxima is used in designing the system where the excitation beam generating means and also the receiver and means for detecting the return beam from the fluorescent coating. Based on the wavelength of the excitation beam, and the absorption in emission spectra properties of the fluorescent coating, a receiving and detecting means for the return beam can be designed that will hone in on the return beam and screen and filter out all other light and electromagnetic radiation. This is critical in designing a system with the appropriate level of detection ability.

Generally the fluorescent coating will be coated on to a standard golf ball. It is highly desirable that the coating be transparent so that it does not alter the look and feel of a conventional golf ball. The coating will be in the form of a polymer dye that can be applied to the ball for example by immersing the balls in the dye, painting the dye on to the ball or spraying the dye on to the ball. Applicant envisages that the dye may be cured by UV once it is applied to the balls. Further the dye should preferably not be bleached by normal solar radiation and thus should have a sufficiently short radiative half life.

At present the applicant mixes the above identified dyes with a two pac urethane lacquer which is typically used to provide the final finish to the outer surface of the golf ball.

An alternative approach to the application of the lacquer is to bond the selected dye with the polymer used to create the outer casing of the ball. Accordingly the dyes are selected in this instance not only because of their desired absorption and emission properties but also on their chemical structure, i.e. the dye has maleimide attachments. Examples of two suitable dyes are those marketed under the product numbers A10255 and A20347 by Invitrogen Australia Pty Limited. As the dyes have maleimide attachments they can be covalently bonded to the polymer used in the construction of the ball's outer shell and thus the dye in this in forms part of the ball's outer shell. Of course it will be appreciated that dyes having amine attachments may also be utilised in such a bonding process.

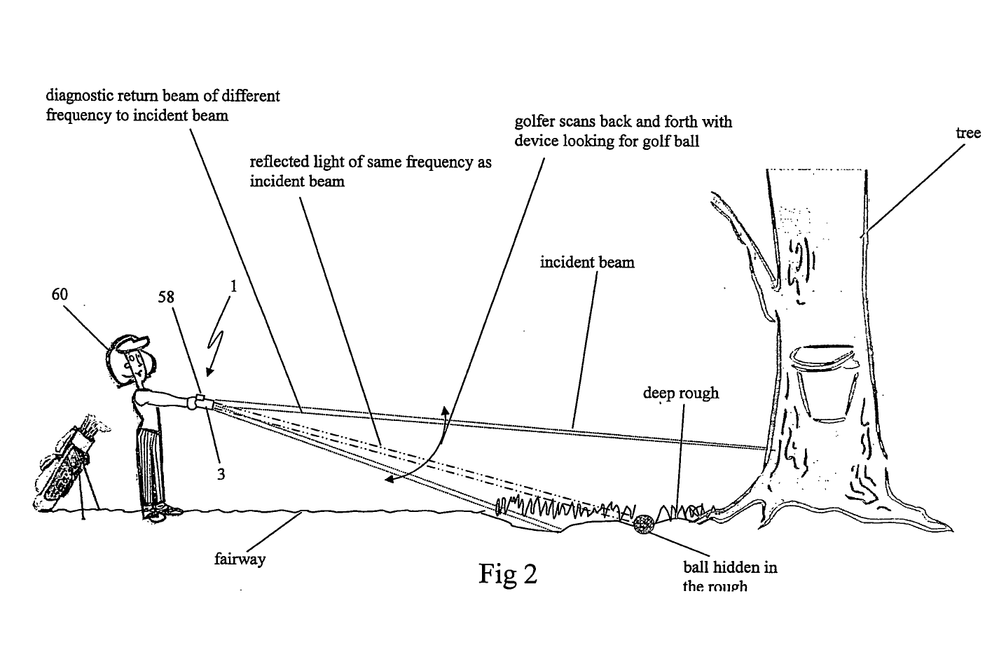

The use of the device to assist in locating a golf ball will now be described in some detail. In use, a golf ball can be partially concealed by leaves and long grass as shown in FIG. 2.

A golfer 60 and/or caddy approaches the general area of the ball 2 from the direction of the tee. As they walk up they hold the device 1 in their hand 51 and point it in the general direction of the ball 2.

The device 1 radiates an excitation beam from the laser through the lens and telescope towards the general area of the ball 2. The device may be swept left and right while it is being pointed in the general direction of the ball. When light or infrared radiation from the excitation beam strikes a part, eg a very small part, of the golf ball it is absorbed by the fluorescent coating. It then radiates a pulsed return beam of longer wavelength corresponding to the Stokes shift for that fluorescent coating back towards the device.

The return beam passes through the receiving lens and filters before striking the photo receiver and generating a receiver signal. The filters perform the crucial function of filtering out the reflected infrared light from the excitation beam and also incidental ambient sunlight that is reflected back towards the device 1. In this regard the Stokes shift in the emission spectrum of the fluorescent coating is crucial to the working of the system. It results in the return beam having a different wavelength and frequency from the excitation beam and this provides the means to differentiate it and separate it from the excitation beam. In fact the reflected excitation beam can simply be filtered out to leave the return beam to pass through the lens and to the photo receiver. If the Stokes shift did not occur the return beam would be indistinguishable from the excitation beam and the identification of the beam that was being returned by the golf ball from the other beam would be extremely difficult, if not impossible.

Thus the system relies on a careful choice of frequency and wavelength of the excitation beam, a florescent coating that absorbs this magnetic radiation strongly, and then knowledge of the emission spectrum of this coating. Based on this the appropriate filters can be chosen.

The modulated output signal from the photo receiver is then converted to a DC output signal by the phase-sensitive amplifier and this DC output signal is then amplified to the appropriate level to enable it to trigger the beeper and LED when the return beam is received.

When the beeper and LED are activated, the golfer knows that the device has detected the golf ball and has shown its general direction and position. The golfer can then keep the device trained on the ball as they walk up and this enables them to quickly and easily find the ball.

Apparatus for Detecting Fraudulent Credit or Identity Card

A briefly discussed above the fluorescence detection concept of the can also be applied in the field of data security and in particular in the area of credit card and/or personal identity card theft.

In this instance the cards could be coated with a combination of fluorescent dyes in one or more locations. As in the case of the golf ball above the dyes could be covalently bonded with the polymer from which the card is made. The dyes are chosen so as to have both a narrow absorption and emission band selected to match the emission frequency of selected low powered lasers or light emitting diodes or similar.

The card may then be scanned by a dedicated reader comprising the selected lasers or LEDs or similar narrow frequency emitter. The combination of dyes and locations at which they are disposed on the card produces a unique emission spectra (e.g. one dye for the card type (λ₁), another for the year of issue (λ₂) etc) in response to illumination of the dye or dyes by the readers LED. This emission spectra is then processed by the scanning device and matched against a set of stored patterns in order to verify the cards authenticity. In addition the concentrations of dyes could be varied to introduce an extra degree of complexity of the verification code.

If the card reader scanned the card within a closed environment with no or minimal exposure to external light, the scanning lasers or LEDs need only be very low power and the sensing devices could be of high sensitivity without the need to distinguish the return response from the background. In this circumstance the sizes of the areas of the dye could be quite small and possibly the concentrations of the dye could be quite low. In such cases it may be possible that the presence of the dyes would not be readily visible to the naked eye or the dyes could be positioned fitting with the normal colours on the card so that their presence was effectively camouflaged. Therefore this method offers the possibility of the protection mechanism not being readily detectable except by means of the card reader which would be. This provides an extra degree of security since it would be difficult to determine whether the card had been treated or not without the card reader.

Another example of the present inventions applicability in the field of data security is in detecting unauthorised or pirated versions of music CDs, CD ROMs and DVDs. In this instance the upper surface, being the surface carrying the various indicia and promotional art work, could be could be coated with a dye or a combination of dyes in a similar manner to that discussed above. The reader in this application is positioned with in the appropriate player e.g. CD or DVD player, CD or DVD ROM. The reader then scans the upper surface of the disc, upon receipt of the emission spectra of the dye or dyes the reader compares the detected emission against a set of stored patterns in order to verify the disc authenticity.

Apparatus for Locating a Person in a Search and Rescue Application

Another apparatus that has not been illustrated in the drawings has been designed for the search and rescue applications.

The apparatus includes a device, eg a hand held device, that sends our radio waves in the range of 500 MHz to 5 GHz and a directional antenna for directing the waves in the appropriate direction. The device also includes a receiver, eg including an antenna for receiving a return beam and means for processing the return beam and indicating that a return beam has been located.

The apparatus also includes an article to be located in the form of an RFID located in a sealed housing or capsule that is mounted on a life jacket at or near the shoulder lapel area. The RFID includes an ASIC chip which is energised by the incoming beam. It processes has signal and then sends back a return signal or beam.

In use the device is used by the search and rescue party, eg from a helicopter or the like who scan back and forth across the search area with the device. This sends out a pulsed beam of radio waves. If and when the radio waves from the device are received by the RFID then it sends back a diagnostic return signal of different frequency that can be received by the receiver.

By appropriate usage of batteries coupled to the RFID devices and the use of more than one device in series and also amplifiers Applicant believes that a search range of greater than 500 m and possibly more than 1000 m can be achieved.

An advantage of a device and apparatus in accordance with this invention is that it can be used to help find an article coated with fluorescent coating. This can be useful when only a small portion of the area of the article is exposed, or it is dark. It can also be used where a person has simply forgotten where they have left something, eg a set of keys in a garden or a house. It can also be useful to help find partially concealed or camouflaged golf balls. It can also be useful to find a person wearing a jacket with florescent material in the sea or covered with snow.

A further advantage of this device and apparatus is that it can be manufactured from standard commercially available components that can readily be purchased off the shelf. Yet further the device is not overly complex. It utilises a number of principles of physics and particularly optics and combines these with electronics and components of consumer electronics that are readily available. The device can be manufactured and made available to the market at a reasonable price. In fact the cost of the article would be low enough to make the technology available to most, if not all, of the general population.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. An apparatus for locating an article said apparatus including:
a source of electromagnetic radiation capable of illuminating the general area containing the article to be located, wherein the source emits radiation in the red or near infrared bands of the electromagnetic spectrum;
an absorber associated with said article and responsive to said radiation emitted by the source;
an emitter associated with said article and responsive to absorption by said absorber; and
a detector capable of detecting an emission by said emitter and providing an output indicating to the location of said article.

2. The apparatus of claim 1 wherein the source further includes a focusing element for focusing the electromagnetic radiation radiated by said source into a directional beam.

3. The apparatus of claim 2 wherein the focusing element is a collimator.

4. The apparatus of claim 2 wherein the source further includes a beam expander for expanding the directional beam between a width of 15 mm to 25 mm

5. The apparatus of claim 1 wherein the source further includes a filter and/or hot mirror mounted at an angle of 45° to the direction of the electromagnetic radiation radiated by said source.

6. The apparatus of claim 1 wherein the detector includes at least one bandpass filter and at least one wavelength pass filter.

7. The apparatus of claim 6 wherein said at least one bandpass filter is a bandpass interference filter and the wavelength pass filter is a coloured glass filter.

8. The apparatus of claim 1 wherein the detector further includes an aperture stop and a receiving lens.

9. The apparatus of claim 10 wherein said aperture stop is a variable iris and the receiving lens has a focal length in the order of 50 mm to 150 mm.

10. The apparatus of claim 9 wherein the receiving lens is shaped, sized and positioned so as to form a real image of the article on said detector, and wherein the image is sized between 0.5 mm and 5 mm.

11. The apparatus of claim 1, wherein the apparatus further includes an amplifier coupled to said detector for amplifying the output of said detector in the order of 0.5 to 10 volts.

12. The apparatus of claim 11 wherein the amplifier is a trans-impedance amplifier.

13. The apparatus of claim 1 wherein the apparatus further includes a signal generator coupled to said source, and wherein the signal generator pulses the electromagnetic radiation radiated by said source at a predetermined frequency.

14. The apparatus of claim 13 wherein the apparatus further includes a phase sensitive amplifier coupled to an indicator, said phase sensitive amplifier converting the output of said detector to a direct current signal, said direct current signal energising said indicator.

15. The apparatus of claim 14 wherein said indicator means includes at least one visual stimuli and/or at least one audio stimuli.

16. The apparatus of claim 15 wherein said visual stimuli is in the form of a flashing LED and said audio stimuli is in the form of a beeper or buzzer.

17. The apparatus of claim 1 wherein the source is a laser diode and said detector is a photo detector.

18. The apparatus of claim 1 wherein said absorber and said emitter are comprised of a fluorescent material disposed on the outer surface of said article.

19. The apparatus of claim 18 wherein said fluorescent material is selected such that it absorbs strongly in the infrared and/or ultraviolet bands.

20. The apparatus of claim 18 wherein the fluorescent material is a fluorescent dye.

21. The apparatus of claim 20 wherein the fluorescent dye is 3-diethylthiadicarbocyanineiodide or 1,1′,3,3′,3′-hexamethylindodicarbocyanine Iodide.

22. A method of locating an article, the method including the steps of:
providing said article with an absorber selected to absorb incident electromagnetic radiation in the red or near infrared bands of the electromagnetic spectrum;
providing said article with an emitter selected to emit electromagnetic radiation in response to illumination of said absorber by said incident radiation; and
detecting said emitted radiation.

23. The method of claim 22 wherein said method further includes the step of actively illuminating the article with a radiation source wherein said source emits radiation in the red or near infrared bands of the electromagnetic spectrum.

24. The method of claim 23 wherein the steps of providing said article with said absorber and said emitter includes coating the article with a fluorescent material having a characteristic frequency;

25. The method of claim 24 wherein said fluorescent material is selected such that it absorbs strongly in the infrared and/or ultraviolet bands.

26. The method of claim 24 wherein the fluorescent material is a fluorescent dye.

27. The method of claim 26 wherein the fluorescent dye is 3-diethylthiadicarbocyanineiodide or 1,1′,3,3′,3′-hexamethylindodicarbocyanine Iodide.

28. The method of claim 22 further including the step of sweeping said incident electromagnetic radiation across a search area in order to illuminate said absorber.

29. The method of claim 22 wherein said incident electromagnetic radiation is pulsed at a predetermined frequency.

30. The method of claim 24 wherein the step of detecting further includes the step of filtering the detected radiation, wherein the step of filtering includes actively attenuating radiation outside the characteristic frequency.

31. The method claim 22 further including the step of providing an indication to a user upon detecting said emitted radiation.

32. The method of claim 31 wherein the step of providing an indication includes providing a visual stimuli and/or audio stimuli.

33. The method of claim 32 wherein said visual stimuli is in the form of a flashing LED and said audio stimuli is in the form of a beeper or buzzer.
